(19) United States
(12) Patent Application Publication
(10) Pub. No.: US 2004/0152382 A1
(43) Pub. Date: Aug. 5, 2004

(54) Protective garment

(76) Inventor: Rolf Lehmann, Hamburg (DE)

Correspondence Address: KELLY BAUERSFELD LOWRY & KELLEY, LLP, 6320 CANOGA AVENUE, SUITE 1650, WOODLAND HILLS, CA, 91367, US

(21) Appl. No.: 10/757,076

(22) Filed: Jan. 12, 2004

(30) Foreign Application Priority Data
Jan. 31, 2003 (DE) 203 01 580

(51) Int. Cl. B32B 27/04

(52) U.S. Cl. 442/135; 442/134; 442/136

(57) ABSTRACT

In order to provide a textile protective material made of multiple material layers which meets different requirements simultaneously, it is suggested that at least one material layer be a flame-resistant and/or flame-repellent material and at least one further material layer be a cut protection material, and/or a bulletproof or stabproof material.

The present invention relates to a textile protective material, made of multiple material layers, as well as a garment as a cut protection garment such as cut protection leggings, trousers, overalls, jacket, vest, or protective suit.

Garments for cut protection for persons who use power saws are known. The implementation of such cut protection garments is described, for example, in European Standard EN 381-4:1995. The protective garment has fabric, knitted material, or thread scrim made of synthetic, partially high-strength fibers.

A special protective effect is achieved in that the saw teeth grip one or more threads and tear them out of the composite. This bundle of torn-out threads leads to blocking of the bearings or chain guides until the tool is at a standstill (DE 100 36 488 A1).

The top material of such protective garments is typically made of a mixture of cotton and artificial fibers, which is not conducive to wearing comfort.

In another field, specifically in connection with persons who are active in rescue operations or fire departments, a protective garment is also worn. The design of such a protective garment has been described, for example, in European Standards EN 469 and EN 531. Such a protective garment for rescue forces typically has the following features:

nonflammable,

afterburn/afterglow time under 2 seconds,

no melting,

no dripping,

no ignition,

very high heat transfer resistance,

long-lasting water and oil repellent properties,

highly visible through the use of a combination of reflecting and luminescent materials.

A protective garment for firefighters, for example, which is implemented as a heat protection, is known from DE 694 17 757 T2, for example.

Flame-retardant threads and fabrics produced therefrom are known from DE 100 38 030.

In rescue forces in which the use of hand-held motorized devices such as power saws is necessary, the rescue personnel currently use the available cut protection garment, as was described above. In this case, the rescue personnel must give up the features of the protective garment for rescue forces. In particular, giving up fire and melt protection leads to the cut protection garment not being able to be used in all necessary instances.

The present invention is therefore based on the object of providing a protective garment which meets the different requirements simultaneously.

To achieve this object, a textile protective material having the features of Claim 1 and/or a garment having the features of Claim 4 are suggested.

The achievement of the object according to the present invention in this case is that a material layer, as is necessary for implementing a cut protection garment, is combined with a material layer, as is necessary for achieving fire and melt protection, so that a cut protection garment is provided which combines the advantages of the known cut protection garment with the protective garment for rescue personnel.

Through this combination, it is possible to provide a garment which meets the requirements for functionality of protective clothing of rescue forces, which thus has the properties of protective clothing for rescue personnel listed above and, in particular, fulfills the appropriate standards—both for the cut protection garment and for the garment of rescue personnel.

It is advantageously provided that the material which is used as a flame-resistant and/or flame-repellent material is implemented as a fire and melt protection.

In the material layer which is used as the cut protection material, it is provided that a layer made of lining threads and loops, which blocks the tool in case of contact, is positioned on the machine side in a way known per se over a textile base material for protection against injuries through motorized tools such as chainsaws or circular saws.

The garment may advantageously be implemented as cut protection leggings, trousers, overalls, jacket, vest, or protective suit.

An exemplary embodiment of the present invention is illustrated in the drawing.

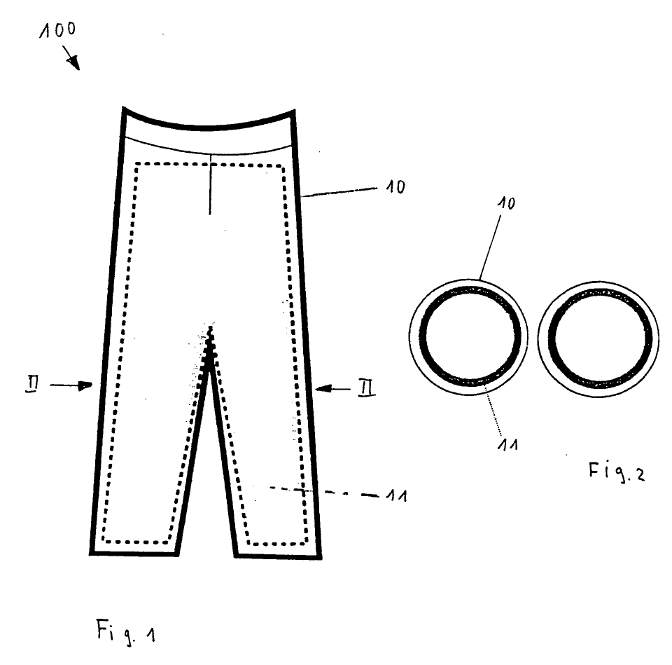

FIG. 1 shows a schematic top view of cut protection trousers with the material construction indicated,

FIG. 2 shows a schematic illustration of a cross section II-II through the cut protection trousers shown in FIG. 1.

The cut protection trousers 100 shown purely schematically in FIGS. 1 and 2 have an external cut which is a comfortable cut typical for a work garment of this type. In principle, no limits are placed on its design in regard to the design of the cut, the tear closure, pockets, patch pockets, and cuffs. These designs are given in each case by the relevant standards and guidelines. The construction of the cut protection trousers is such that the external fabric 10 is made of a fire-safe material in accordance with EN 469/531, e.g., from “Nomex III”. An example is “Nomex III” from DuPont. A cut protection insert in accordance with EN 381 is implemented on the inside as a cut protection material 11, as is shown in FIG. 2.

Of course, this is only the basic construction. It is possible to produce the garment from a multilayer material, a flame-resistant external fireproof material 10, a moisture barrier (not shown in the drawing), and a thermally insulating liner (also not shown) able to be provided in sequence, for example, after which the cut protection insert follows, which is formed from a cut protection material 11, on which a layer made of lining threads and loops, which blocks the tool in case of contact, is positioned on the machine side, i.e., directed toward the outer fire protection fabric, in a way known per se over a textile base material for protection against injuries through motorized tools such as chainsaws or circular saws. An inner liner (also not shown) may also be provided on the inside in order to increase the wearing comfort.

In order to increase the manifold applicability of such a garment, a bulletproof or stabproof insert may also be positioned instead of the cut protection insert, so that such a garment is also usable in crisis regions by military or police rescue forces.

The present invention is not restricted to the exemplary embodiment of cut protection trousers shown in the drawing. The same basic construction is conceivable for cut protection leggings, trousers, overalls, jackets, vest, or protective suits. In principle, any corresponding garment may be produced from such a textile protective material in order to achieve the advantageous effects.

1. A textile protective material, made of multiple material layers, characterized in that at least one material layer is a flame-resistant and/or flame-repellent material and at least one further material layer is a cut protection material, and/or a bulletproof or stabproof material.

2. The textile protective material according to claim 1, characterized in that the flame-resistant and/or flame-repellent material is implemented as a fire and melt protection.

3. The textile protective material according to claim 1 or 2, characterized in that the cut protection material is positioned over a textile base material on the machine side in a way known per se as a layer made of lining threads and loops, which blocks the tool in case of contact, for protection against injuries through motorized tools such as chainsaws or circular saws.

4. A garment as a cut protection garment such as cut protection leggings, trousers, overalls, jacket, vest, or protective suit, characterized in that it is implemented from a textile protective material according to one of claims 1 through 3.

5. A use of a textile protective material according to one of claims 1 through 3 for implementing a protective garment.
